(19) United States
(12) Patent Application Publication
(10) Pub. No.: US 2010/0281088 A1
(43) Pub. Date: Nov. 4, 2010

(54) Integrated true random number generator

(75) Inventor: Scott A. Wilber, Gainesville, FL (US)

Correspondence Address: Thomas Swenson, 1118 13th Street, A-5, BOULDER, CO, 80302, US

(73) Assignee: Psigenics Corporation, Carson City, NV (US)

(21) Appl. No.: 12/799,205

(22) Filed: Apr. 20, 2010

Related U.S. Application Data
(60) Provisional application No. 61/214,836, filed on Apr. 29, 2009.

(51) Int. Cl. G06F 7/58

(52) U.S. Cl. 708/251; 708/255

(57) ABSTRACT

A true random number generator (TRNG) in an integrated circuit comprises a plurality of independent ring oscillators with multiple output taps combined into enhanced outputs, a plurality of delay lines, a combiner-sampler and a source of a clock signal. Some embodiments provide a TRNG that is resettable, allowing one or more independent random numbers to be generated in response to a trigger signal.

### RELATED APPLICATIONS

This application claims the benefit under 35 USC 119(e) of U.S. Provisional Application Ser. No. 61/214,836, filed Apr. 29, 2009, by Wilber.

### FIELD OF THE INVENTION

The present invention relates to random number generation, and more specifically to non-deterministic or true random number generation in an integrated circuit.

### BACKGROUND

Applications utilizing true random numbers have steadily increased in number and type during the “information age.” True random number generators (TRNG's) are available in virtually every new personal computer sold today. They are used for data security in some way in practically every level and form of communication, financial transaction and game of chance such as our ubiquitous lotteries and online gaming. The need for improved quality and increased speed of generation has been equally significant.

Devices and methods for generating non-deterministic or true random numbers are well known in the art. Given their commercial importance, it is not surprising that literally hundreds of references can be found describing various designs and ideas for ways of supplying this ever-increasing demand. See, for example, U.S. Pat. No. 7,356,552, issued Apr. 8, 2008, to Hars, U.S. Pat. No. 7,349,935, issued Mar. 25, 2008, to Atsumi et al., U.S. Pat. No. 7,330,328, issued Feb. 12, 2008, to Xie et al., U.S. Pat. No. 7,284,024, issued Oct. 16, 2007, to Trifinov et al., and U.S. Pat. No. 6,862,605, issued Mar. 1, 2005, to Wilber. Most modern electronic devices are based on integrated circuit (IC) technology or large scale integration (LSI) so it is advantageous to provide devices and methods for random number generation that are compatible with IC and LSI technology. Examples of IC- or LSI-based designs are disclosed in U.S. Pat. No. 7,111,029, issued Sep. 19, 2006, to Fujita et al., U.S. Patent Application Publication No. 2003/0135527, by Lundberg, published Jul. 17, 2003, and U.S. Pat. No. 7,356,552.

In addition to the desirability of using IC compatible technology, it is also useful in many applications to implement a true random generator in a programmable logic device such as a Field-Programmable Gate Array (FPGA). Implementations of this type can be used in custom devices, during hardware and software development, and in devices or systems that are reprogrammable to allow for easily updating firmware or operating programs.

There is a need for a true random number generator (TRNG) that is able to produce high-quality (i.e., entropy of at least 0.99 bits/bit) random numbers, at a high frequency, with a high degree of repeatability and reliability, while minimizing power drain and the number of logic gates required. There is also a need for a TRNG that is operable to generate random output on demand, that is, exclusively after a request is made.

### SUMMARY OF THE INVENTION

The invention satisfies some of the needs and requirements mentioned above by providing devices, systems and methods for generating high-quality true random numbers at a high frequency with a high degree of repeatability. Preferred embodiments are implemented using substantially only integrated circuits.

A basic embodiment of a true random number generator (TRNG) in an integrated circuit comprises: a plurality of independent ring oscillators; a plurality of delay lines; a combiner-sampler; and a source of a clock signal. Each of the ring oscillators has a plurality of gates, a plurality of sampling taps and an Exclusive-Or (XOR) function, wherein each of the sampling taps is operable to tap an output signal from one of the gates, and the XOR function is operable to receive a plurality of outputs signals from the gates to produce enhanced output. Each of the delay lines comprises a plurality of gates and a plurality of sampling taps, wherein each of the delay lines is operable to receive enhanced output from one of the ring oscillators, each of the sampling taps is operable to tap an output signal from one of the gates, and each of the delay lines is operable to generate a plurality of progressively delayed output signals. The combiner sampler has a plurality of primary XOR gates, a plurality of secondary XOR gates, and a plurality of data latches, each data latch being operable to latch data from an XOR gate, wherein each of the primary XOR gates is operable to combine pairs of the delayed output signals from different delay lines to produce a primary output signal, and the secondary XOR gates are operable together to combine signals latched from a plurality of the latched primary output signals to produce a random binary output. The clock signal clocks the data latches in the combiner-sampler.

A basic embodiment of a method in accordance with the invention for generating a sequence of true random numbers in an integrated circuit comprises: providing a clock signal; providing at least two output signals from each of at least two independent ring oscillators; combining the at least two output signals into an enhanced oscillator output for each of the ring oscillators; producing at least two delayed output signals in a signal delay circuit from each of the enhanced oscillator outputs; using the clock signal and the delayed output signals to produce a multiplicity of sampled signals; and combining the sampled signals in an output combiner circuit to produce a sequence of random numbers. In some embodiments, the steps of combining the at least two output signals and the step of combining the sampled signals are performed by an XOR function.

Some embodiments in accordance with the invention comprise a resettable TRNG that is operable to generate a random number on demand, immediately (within about a microsecond or less) after a request for a random number is made. A resettable TRNG in accordance with the invention comprises: a resettable ring oscillator; a negative pulse generator; a source of a clock signal; and a processor. A resettable ring oscillator comprises a plurality of gates, an enable input, and reset input to each of the gates. The reset inputs are operable to provide a reset time for the ring oscillator of only one gate delay. A negative pulse generator is operable to produce a precisely controlled, short negative-going pulse triggered on the rising edge of a clock input signal. A processor is operable to receive output from a latched counter to convert the output into a random number output.

Some embodiments in accordance with the invention comprise a triggerable true random number generator in an integrated circuit operable to produce a random output in response to an input trigger signal. A triggerable TRNG in accordance with the invention comprises: at least one resettable ring oscillator; at least one delay line comprising a plurality of gates and a plurality of sampling taps; a resettable combiner-sampler having a plurality of data latches and a plurality of secondary XOR gates; a controller for accepting a trigger input for initiating a random number generation; and a source of a clock signal. The at least one resettable ring oscillator includes a plurality of gates, a plurality of sampling taps and an XOR function, wherein each of the sampling taps is operable to tap an output signal from one of the gates, and the XOR function is operable to receive a plurality of output signals from the gates to produce enhanced output. The at least one delay line comprises a plurality of gates and a plurality of sampling taps, wherein the at the least one delay line is operable to receive the enhanced output from the at least one resettable ring oscillator, each of the sampling taps is operable to tap an output signal from one of the gates, and the at least one delay line is operable to generate a plurality of progressively delayed output signals. The resettable combiner-sampler comprises a plurality of data latches and a plurality of secondary XOR gates, wherein each of the data latches is operable to latch one of the progressively delayed output signals to produce a latched primary output signal, and the secondary XOR gates are operable together to combine the latched primary output signals into a combiner-sampler output. The controller is operable to provide an enable output for enabling the at least one resettable ring oscillator and resetting the data latches in the resettable combiner-sampler, and is further operable to provide a latch clock for latching the combiner-sampler output in an output latch to produce a random output. The source of a clock signal is operable to clock the controller, the data latches in the resettable combiner-sampler and the output latch. In some embodiments, a triggerable TRNG further comprises a continuous XOR latch operable to accept the resettable combiner-sampler output to produce a continuous XOR output, wherein the output latch is operable to accept the continuous XOR output to produce the random output. In some embodiments, triggerable TRNG comprises: two resettable ring oscillators and two delay lines; and a resettable combiner-sampler having a plurality of primary XOR gates, a plurality of secondary XOR gates, and a plurality of data latches, wherein each data latch is operable to latch data from an XOR gate, each of the primary XOR gates is operable to combine pairs of the delayed output signals from different delay lines to produce a latched primary output signal, and the secondary XOR gates are operable together to combine the latched primary output signals into a single combiner-sampler output. In some embodiments, a triggerable TRNG further comprises a continuous XOR latch operable to accept the resettable combiner-sampler output to produce a continuous XOR output, wherein the output latch is operable to accept the continuous XOR output to produce the random output. In some embodiments of a triggerable TRNG, the fractional bias and the first 32 orders of autocorrelation measured in an output sequence produced by the triggerable true random number generator are less than 10 ppm with 95% statistical confidence. In some embodiments of a triggerable TRNG, the fractional bias and the first 32 orders of autocorrelation measured in an output sequence produced by the triggerable true random number generator are less than 1 ppm with 95% statistical confidence.

Other features, characteristics and advantages of embodiments in accordance with the invention will become apparent from consideration of the description and drawings below.

### BRIEF DESCRIPTION OF DRAWINGS

A more complete understanding of the invention may be obtained by reference to the drawings, in which:

FIG. 1 depicts a 6-gate ring oscillator having two taps that is operable to produce an enhanced output, EO1;

FIG. 2 illustrates a 9-gate ring oscillator having three taps that is operable to produce an enhanced output, EO2;

FIG. 3 depicts a delay line having 4 non-inverting gates that is operable to generate a plurality of progressively delayed outputs from the input signal, EO1;

FIG. 4 depicts a combiner-sampler in accordance with the invention that is operable to combine and resample the eight delayed outputs D1a, D1b, D1c, D1d, D2a, D2b, D2c and D2d produced by first and second four-gate delay lines;

FIG. 5 depicts a resettable 3-gate ring oscillator having an enable input that is operable to enable each gate or reset the gates when the enable is in the low state;

FIG. 6 depicts a negative pulse generator that is operable to produce a precisely controlled, short negative-going pulse triggered on the rising edge of an initiator source input;

FIG. 7 contains a timing diagram 300 showing the timing relationships of an Initiator source signal, a derived enable signal and a ring output signal;

FIG. 8 contains a block diagram of an embodiment of a TRNG 400 in accordance with the present invention in which input signals, ring output and enable are provided by circuits such as those depicted in FIGS. 5 and 6; and

FIG. 9 contains a block diagram of a triggerable TRNG 500 in accordance with the present invention.

### DETAILED DESCRIPTION OF THE INVENTION

The invention is described herein with reference to FIGS. 1-9. It should be understood that these figures, depicting elements, systems and processes of embodiments in accordance with the invention, are not meant to be actual views or diagrams of any particular portion of an actual equipment component, apparatus or process. The figures instead show idealized representations that are employed to explain more clearly and fully the structures, systems and methods of the invention than would otherwise be possible. Also, the figures represent only one of innumerable variations of structures and systems that could be made or adapted to use a method of the invention. Devices and methods are described with numerous specific details, such as components, oscillator frequencies and mathematical techniques, in order to provide a thorough understanding of the present invention. It will be obvious to one skilled in the art that these specific details are not required to practice the present invention. It is clear that embodiments in accordance with the invention can be practiced using structures, devices and processes different from those described with reference to FIGS. 1-9. The preferred embodiments described herein are exemplary and are not intended to limit the scope of the invention.

For the sake of clarity, in some of the figures below, the same reference numeral is used to designate structures and components that are the same or are similar in the various embodiments described.

The terms “non-deterministic”, “non-deterministic bits”, “true random number”, “true random bits” and related terms are used in this specification interchangeably to designate a quality of true randomness of a number or bit of information, which means that the number or bit cannot be calculated or determined with certainty in advance. Non-deterministic random numbers can be thought to be arbitrary, unknowable, and unpredictable. For the sake of brevity, the abbreviated terms “random number” and “random numbers” are sometimes used in this specification synonymously with the terms denoting non-deterministic numbers, such as “non-deterministic random number” and “true random numbers”. The singular and plural forms of the word “number” are used broadly and sometimes used interchangeably in this specification. For example, the term “non-deterministic random numbers” may indicate a sequence or subsequence of binary bits or other digital numbers in some embodiments. The terms “serial correlation” and “autocorrelation” are used interchangeably.

Every true random number generator (TRNG) requires a physical source of entropy. Entropy is in general a measure of disorder in a physical system. In this specification, entropy refers to a measure of how unpredictable the measured properties of the entropy source are. A simple analogy is the flip of a coin. If each flip is entirely unpredictable, that is, each flip has exactly a 50/50 chance of being heads (a “fair” coin), the entropy is said to be 1. If a coin had two heads, every flip of that coin would be completely predictable and the entropy would be 0.

FIG. 1 depicts schematically a six-gate ring oscillator 100 in accordance with the invention that is operable to serve as an independent high-frequency oscillating signal source in a TRNG in accordance with the invention. Ring oscillator 100 comprises six gates: five non-inverting gates 102 and one inverting gate 104. Ring oscillator 100 further comprises two taps 106, each of which serves to tap an output signal from two gates 102 and to provide them as input to an Exclusive-Or (XOR) function 108. The output of XOR function 108 is enhanced output 110, also designated in FIG. 1 as EO1. In preferred embodiments, gates 102, 104 are programmable logic elements in an integrated circuit, for example, in a field-programmable logic array (FPGA). Associated with each gate 102, 104 are transistors and various resistive elements, which are sources of entropy that produce transistor and thermal noise. The noise signal from these sources combines with the otherwise stable logic transitions in the logic elements to produce non-deterministic jitter in the logic signal transition timing. Increasing the number of gates in a ring oscillator increases the total amount of entropy available for measurement. By itself, increasing the number of gates slows the frequency of oscillation and slows the rate of measurement of entropy, which measurement can only occur during a logic transition. It would be possible to increase the frequency of entropy measurement simply by decreasing the number of gates in the ring oscillator. Doing this, however, would cause an undesirable increase in power consumption as well as reduce the available entropy per measurement. Using a plurality of taps in accordance with the invention, however, increases the frequency of the output and, thereby, increases the rate of entropy measurement without unnecessarily increasing power consumption or reducing the entropy in each measurement.

FIG. 2 depicts schematically a nine-gate ring oscillator 120 that is operable to serve as an independent high-frequency oscillating signal source in a TRNG in accordance with the invention. Ring oscillator 120 comprises nine gates: eight non-inverting gates 122 and one inverting gate 124. Ring oscillator 120 further comprises three taps 126, each of which serves to tap an output signal from one of gates 122 and provide it as input to an Exclusive-Or (XOR) function 128. The output of XOR function 128 is enhanced output 130, also designated in FIG. 2 as EO2. It is understood that a ring oscillator in accordance with the invention may have a different number of gates and taps than ring oscillators 100 and 120. It is further understood that these ring oscillators may contain a different number of inverting versus non-inverting gates, as long as each ring has an odd number of inverting gates.

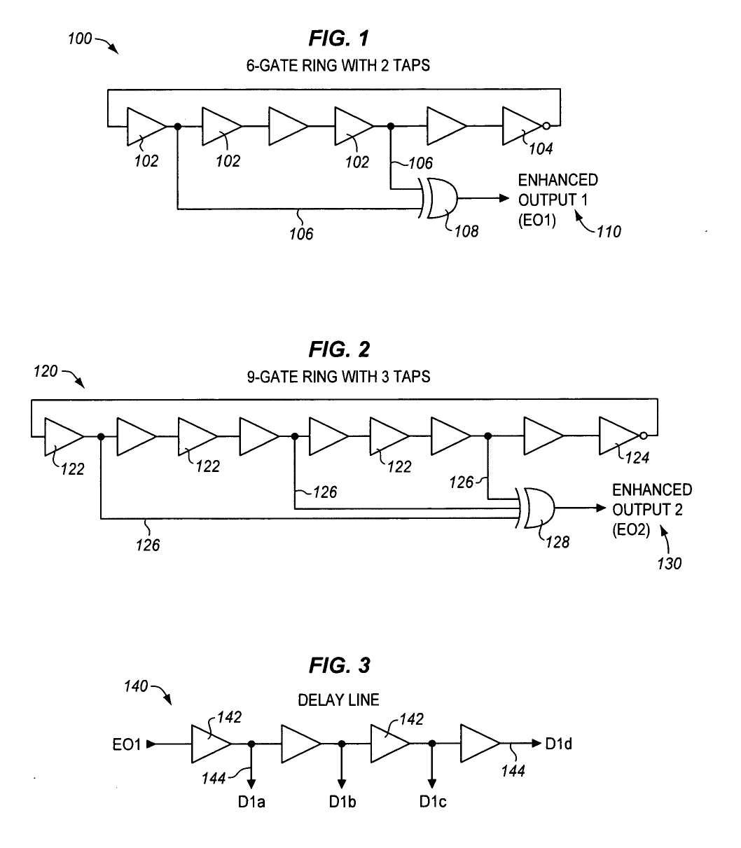

FIG. 3 depicts schematically a delay line 140 in accordance with the invention that is operable to generate a plurality of progressively delayed outputs. Delay line 140 comprises four non-inverting gates 142. Delay line 140 is operable to receive enhanced output from a ring oscillator in accordance with the invention; for example, enhanced output 110 of FIG. 1. The input of delay line 140 depicted in FIG. 3 is EO1. Delay line 140 further comprises four taps 144, each tap 144 being operable to sample the output of a gate 142. Accordingly, delay line 140 is operable to produce four progressively delayed outputs D1a, D1b, D1c and D1d. It is understood that a delay line in accordance with the invention may have more or fewer gates and taps than delay line 140.

Preferred embodiments of a TRNG in accordance with the invention comprise a delay line for each enhanced output of a ring oscillator. For example, an exemplary TRNG in accordance with the invention having ring oscillators 100 and 120 comprises a first four-gate delay line 140, which accepts enhanced output 110 (EO1) from ring oscillator 100, and a second four-gate delay line (not shown here), which accepts enhanced output 130 (EO2) from ring oscillator 120 and which produces delayed outputs D2a, D2b, D2c and D2d. Preferred embodiments of a delay line in accordance with the invention are implemented as logic elements or gates, for example, in a FPGA.

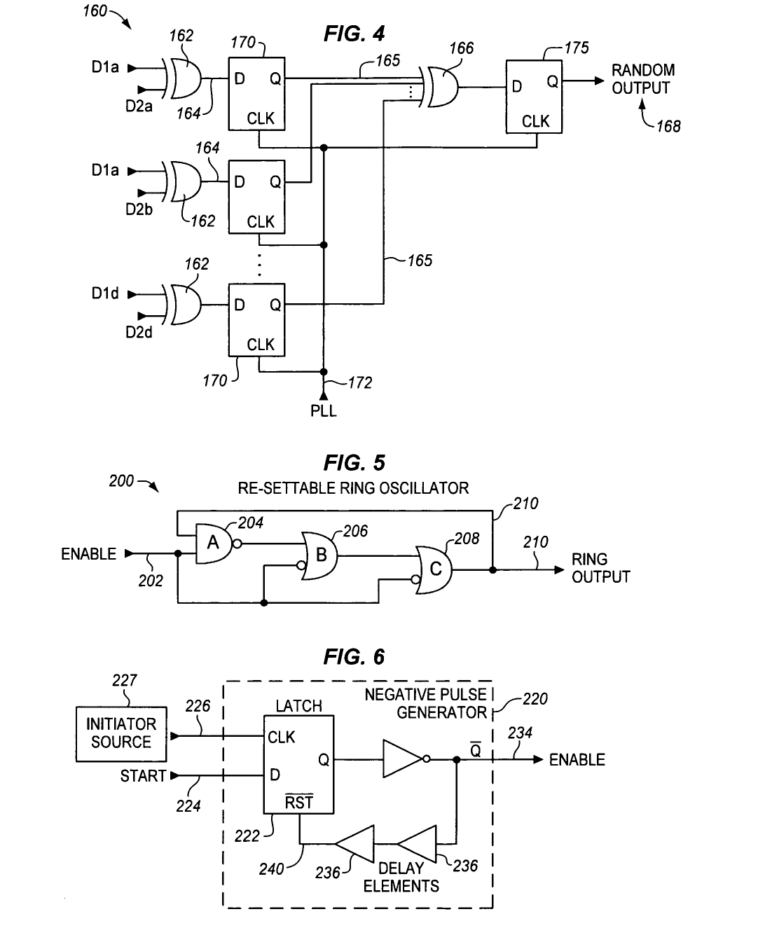

A preferred TRNG in accordance with the invention includes a combiner-sampler that is operable to combine and resample the delayed output signals from a plurality of delay lines to generate random binary output. FIG. 4 depicts a combiner-sampler 160 in accordance with the invention that is operable to combine and resample the eight delayed outputs D1a, D1b, D1c, D1d, D2a, D2b, D2c and D2d produced by the first and second four-gate delay lines discussed above. Combiner-sampler 160 comprises 16 XOR gates 162. Each XOR gate 162 is operable to combine one of the binary output signals D1a, D1b, D1c or D1d with one of the binary output signals D2a, D2b, D2c or D2d (total of 16 pairs), so that each XOR gate 162 produces a primary output signal 164. A combiner-sampler 160 further comprises five four-input combiner XOR gates 166, equivalent to a single 16-input XOR function, that is operable to combine signals on 16 binary bit lines 165 to produce a random binary output signal (binary bit) 168. As depicted in FIG. 4, combiner-sampler 160 further comprises a plurality of data latches 170 for latching binary bits from XOR gates 162 (each data latch 170 corresponding to one of XOR gates 162) and a data latch 175 for latching the output of combiner XOR 166 to produce random output 168. Combiner-sampler 160 further comprises an additional independent oscillator (not shown) connected to a phase locked-loop (PLL) frequency multiplier. The PLL frequency multiplier multiplies the frequency of the independent oscillator and supplies it as a clock signal 172 to clock data latches 170, 175. Some embodiments include randomness correction of random output 168. Thus, some embodiments of TRNG in accordance with the invention comprise: a plurality of ring oscillators, as described above with reference to FIGS. 1 and 2; a plurality of corresponding delay lines, as described above with reference to FIG. 3; and a combiner-sampler, as described above with reference to FIG. 4. A benefit of the plurality of gates and taps in ring oscillators 100, 120 and in delay lines 140 is that they increase the capability to sample entropy, which can only occur during a logic transition. The delayed outputs, D1a-D2d, provide 16 combinations of outputs to be sampled versus the only one from the two outputs, EO1 and EO2. Increasing the number of combinations in this way increases the rate of entropy captured in the sampled outputs, 164 and 168.

In some exemplary embodiments of a TRNG in accordance with the invention, the entropy source is a combination of thermal or Johnson noise and transistor noise. Thermal noise is produced by thermally excited vibration of electrons in every circuit element with resistance. Its statistical properties are well known and its noise spectrum is flat or “white.” Transistor noise is more complex and its amplitude is frequency dependent. The exact mixture of transistor noise components also depends on the type of transistor, such as a junction or MOS. At low frequencies the transistor noise spectrum is dominated by the well-known 1/f response. Above the “knee” in the 1/f spectrum, shot noise and thermal noise become dominant, producing a relatively flat noise spectrum.

In some exemplary embodiments of a TRNG in accordance with the invention, four independent, high-frequency ring oscillator signal sources (similar to the ring oscillators discussed above with reference to FIGS. 1 and 2), each including combined noise signals of the type described above, continuously operate at different frequencies between 200 and 400 MHz. In some embodiments, each of the ring oscillators contains a total of from 10 to 16 gates (e.g., gates 102, 104), including an odd number of one or more inverting gates (e.g., gate 104). In preferred embodiments, each of the ring oscillators contains a total number of gates different from the other ring oscillators. Each of the ring oscillators contains a total number of from two to four taps. Varying the number of gates and taps increases the independence of signals between the various ring oscillators. Each of the four resulting noisy oscillator signals (e.g., EO1, EO2, etc.) is sent through one of four multi-stage (i.e., multigate) delay lines, as discussed above with reference to FIG. 3, to produce a total of 16 additional noisy outputs. Combinations of 32 pairs of these additional noisy outputs are used to produce 32 sampled binary signals using two combiner-samplers similar to combiner-sampler 160 in FIG. 4. The sampled binary signals are combined and resampled at an output frequency of 112 MHz. The effect of the delay lines and the many permuted binary samples is to greatly increase the rate of sampling of the entropy, that is, the unpredictability of the combined output bits. The two random binary outputs, one from each of the two combiner-samplers, are combined in another XOR gate to produce a random binary output. Some embodiments include randomness correction of random output.

Some preferred embodiments of a TRNG comprise three independent generators, each comprising four independent ring oscillators, of the type described above. The statistics of each of these three generators is continuously monitored in the generator hardware. The monitoring includes 1/0 bias, first-order autocorrelation and an estimated minimum entropy. The outputs of each of the three generators is then sent through a linear feedback shift register (LFSR) whitening function to correct defects in statistical randomness. The LFSRs do not change the total amount of entropy, but distribute it equally over the bits in the output sequences. The three corrected outputs are combined by XOR function and finally 56 of these bits (112 bits if the output rate is set to 1 Mega-bit per second (Mbps)) are combined in another XOR to produce each final output bit. The internal hardware monitoring requires at least two of the three generators to have an estimated entropy of at least 0.9 bits/bit. If this requirement fails, the output from the generator is halted. Output bits are also tested for entropy, and the generator is halted if the output entropy falls below 0.99 bits/bit. The internal hardware testing also acts as a startup test program. No random data is produced as output until a block of 1,048,576 bits (2²⁰ bits) from at least two of the three redundant generators has produced the required minimum entropy level.

In some embodiments, software in a host computer monitors the flow of data from the generator when connected to the computer. If the monitoring program detects a halt condition, a request for the internal statistics is automatically generated. These statistics are checked to determine if there has been an actual fault in the hardware, and if this check indicates a fault, an error message is generated and no random data is provided. The automatic check of the hardware might also indicate there was simply a delay caused by normal functioning in the computer's operating system, programs or other attached components. If the check shows the hardware is operating correctly, the monitoring software restarts the generator output and random data flow resumes. The internal statistical test results are accessible at any time through simple commands in the user interface.

In addition to the hardware run-time testing, the interface software includes a redundant set of continuous testing of the random bits received from the generator. These tests also include 1/0 bias, first-order autocorrelation and estimated minimum entropy. If the estimated minimum entropy falls below 0.99, the interface monitoring program halts data transfer and generates an error message. This halt condition can only be reset by restarting the user interface program. This second level of monitoring reduces the possibility of any fault in transmission or handling before the random data is finally made available for use.

Power for an exemplary TRNG is provided through a USB connector and is filtered at entry into a grounded, 1/16 inch aluminum device enclosure. Independent regulation of power for the TRNG section prevents any external effect on the random number generation by fluctuations in the power source.

The theoretical effect on the output sequence statistics of XOR-ing a number of bits, n, in an input sequence of given statistics is known. See, for example, U.S. Pat. No. 6,324,558, entitled “Random Number Generator and Generation Method”, issued Nov. 27, 2001, to Wilber, which is hereby incorporated by reference. See also, Davies, R., “Exclusive OR (XOR) and hardware random number generators”, Feb. 28, 2002, at http://www.robertnz.net/pdf/xor2.pdf. For n=56, the maximum defect in bias or autocorrelation is less than approximately 100 parts per million (ppm) to the fifth power, or 1 part in 10²⁰. This assumes statistical defects as large as 100 ppm in the output of the LFSR whitening function, while the actual level is typically below 10 ppm. A sequence of any testable length with statistical defects so low is indistinguishable from a theoretically perfect random sequence. The output of some preferred embodiments in accordance with the invention is capable of passing any provably correct test for randomness. In some embodiments, the entropy level of the output bits is indistinguishable from 1.0 since more than 100 bits of true entropy (nominally 150-160 bits) are used to produce each output bit. The generator output bits are transferred at a rate of 2 Mbps (jumper selectable to 1 Mbps) via USB interface to a TRNG driver in a computer. In some embodiments, these bits are made available to computer programs by ActiveX communications in a number of different formats including 32-bit integers, 48-bit [0, 1) uniformly distributed fractions and mean=0.0, standard deviation=1.0 Gaussian variates of maximum ±8.0 standard deviations (SD).

The number of bits in a binary sequence required to test bias or autocorrelation to a 95% statistical confidence level is approximately (1.96/fractional defect)². To test for a defect (i.e., a deviation from theoretical randomness) of 10 ppm (±0.00001) requires 38.4 billion bits; to test for a defect of 1 ppm requires 3.84 trillion bits. The fractional bias, B₂, is defined as: B₂=2 (sum of 1's in sequence/n)−1, where n is the total number of bits in the sequence. The autocorrelation of order i, AC(i)=1-2 (sum of XOR(i)/(n−i)), where the sum of XOR(i) is the sum of the XOR function of the bits in the sequence separated by i shifts, from the first bit to the n−n^{th} bit. For example, for i=2, sum the XOR function of the 1^{st} and 3^{rd} bits, the 2^{nd} and 4^{th} bits, et cetera, up to the n−2^{th} and n^{th} bits.

The random number generation method used in some preferred embodiments of TRNGs in accordance with the invention is highly resistant to failure due to long-term aging effects and is tolerant to expected variations in components from different production runs. The high level of redundancy provided by a plurality of independent generators and the large number of entropic bits used to produce each output bit ensures consistent, high quality true random numbers for any application. A benefit of TRNGs in accordance with the invention is a repeatably high-quality random output at high generation rates using relatively few gates and low power, and high resistance to failure of output random numbers due to redundant hardware generators in one integrated circuit.

Some TRNGs in accordance with the invention, as described herein with reference to FIGS. 5-9, are operable to generate a random number on demand, immediately (within about a microsecond or less) after a request for a random number is made. In such embodiments, a random number is generated entirely after the request is made. This is useful for demonstrating certain effects, including experiments with quantum mechanics, faster than light communication and prediction of future events.

FIG. 5 depicts a resettable 3-gate ring oscillator 200 having an enable input 202 that is operable to enable each gate 204 (gate A), 206 (gate B), 208 (gate C) or reset the gates when enable is in the low state. Ring oscillator 200 is operable to generate ring output 210. Enable input 202 is able to provide a reset time for the oscillator of only one gate delay when it is set to a low state. Ring oscillator 200 allows timing to be precisely controlled because it provides for resetting every element of the oscillator. Using a similar approach, some embodiments of delay lines are designed to be resettable. Other techniques (not shown here) for making ring oscillators and/or delay lines resettable are implemented in some embodiments. One exemplary technique for making a ring oscillator or a delay line resettable is: in an OR gate having one inverted input, when the enable line is low, the output of every gate is high and is maintained high.

FIG. 6 depicts a negative pulse generator 220 that is operable to produce a precisely controlled, short (approximately 1-10 ns) negative-going pulse triggered on the rising edge of an initiator source signal 226 from initiator source 227. The duration of the pulse is determined by the type and number of delay elements 236 driving the/reset line 240. Note that the 7′ character indicates the reset line is active low. A “D” or data input is provided that disables the generator when it is at a low or zero signal level. Some embodiments (not shown here) provide for resetting signal delay elements. A start input 224 is operable to allow the negative pulse generator to produce an output only when it is in the high state.

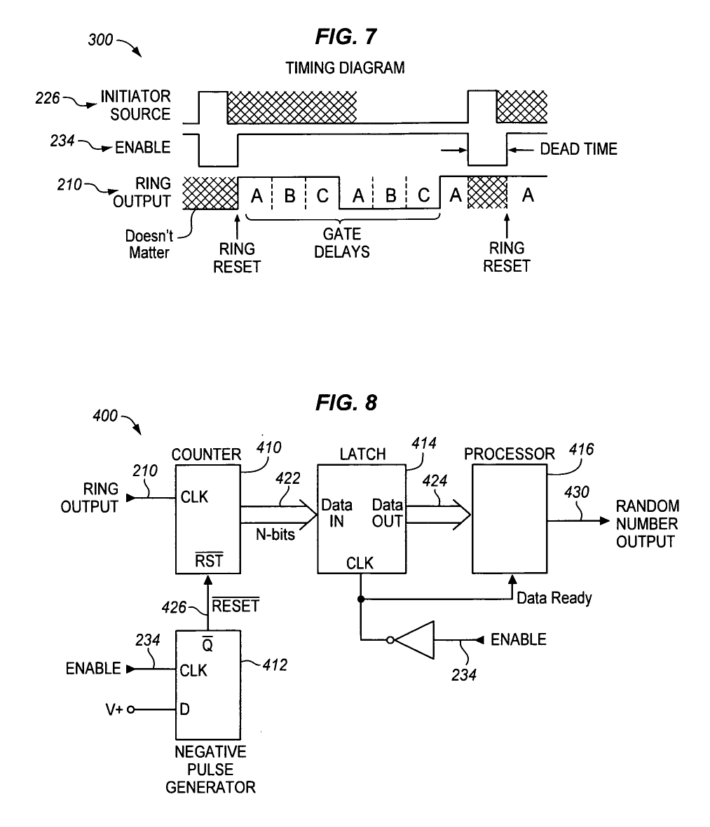

FIG. 7 contains a timing diagram 300 showing the timing relationships of an initiator source signal (e.g., initiator source signal 226 in FIG. 6), a derived enable signal (e.g., enable 234 in FIG. 6) and a ring output signal (e.g., ring output 210 in FIG. 5). The delays caused by propagation delay through each of the gates, A, B and C, are included to show how they produce a complete output cycle of the ring output.

FIG. 8 contains a block diagram of an embodiment of a resettable TRNG 400 in accordance with the present invention. Ring output 210 and enable 234 are provided by circuits such as those depicted in FIGS. 5 and 6. Resettable TRNG 400 includes a counter 410, negative pulse generator 412, latch 414 and processor 416. Counter 410 counts the number of output cycles (specifically the rising edges of each cycle) from a resettable ring oscillator (e.g., ring oscillator 200) when a start signal (e.g., start signal 224) is set to high. Data 422, the N-bit wide parallel output from counter 410, is latched into latch 414 at the end of a counting cycle. Also, a signal 424, the N-bit wide data word that was present at the latch input when the latch was clocked by the falling edge of enable signal 234, is sent to processor 416 when new data is ready to be processed. This sequence of events is initiated by an initiator source signal 226 (FIGS. 6-7), which produces a brief negative pulse from negative pulse generator 220 triggered by the rising edge of initiator source signal 226. The falling edge of enable signal 234 clocks latch 414, which latches data 422 from the previous count, and the rising edge of enable signal 234 resets counter 410 to zero. Reset signal 426 for resetting counter 410 is generated by negative pulse generator 412, which has a design the same as negative pulse generator 220 with the “D” input tied to V+ and the rising edge of enable input 234 initiating the negative pulse output. All of these operations occur asynchronously with any system clock or continuous clock signal. It is the asynchronous nature of TRNG 400, controlled only by enable signal 234, which allows this embodiment to produce output random numbers 430 that have very high statistical quality, i.e., having very low bias and serial correlation, without additional randomness correction after the processor output.

The design and function of a processor in a TRNG 400 depends on the type of initiator source (e.g., initiator source 227 connected to negative pulse generator 220). For example, when the source is nuclear decay, an exemplary technique comprises a known technique for processing pulses from a radioactive decay detector to obtain random numbers. An exemplary approach is to get a count from two pairs of pulses, the first pulse in a pair starts a new count and the second pulse produces the count output. If the first count is higher, the output is “1”, and if the second count is higher, the output is “0”. If the counts are equal no output is generated and the steps in the generation sequence must be repeated. In some embodiments, the initiator source is an oscillator. In such embodiments, the counter is a one-bit latch, that is, a counter which acts as a toggle flip-flop. Accordingly, in such embodiments, the processor need not perform additional processing of a random output bit.

A resettable TRNG 400 is operable to generate a quantum mechanical random number on demand, immediately (within about a microsecond) after a request for a random number is made. A resettable TRNG 400 is operable to generate a quantum mechanical random number that is very close to defect-free (e.g., has expected statistical defects in a range of about from less than 100 ppm to less than 1 ppm) even without performing any randomness correction. The design of a resettable TRNG 400 compensates for the inherent imperfections in gates and logic elements that are the common causes of randomness defects.

A resettable TRNG in accordance with the present invention is operable to produce true random numbers from virtually any source of a sequence of randomly timed events, such as radioactive decay, photon detection, keypress timing or receipt of preselected or varying patterns of Internet (or any other) data. Some embodiments of a TRNG in accordance with the invention include combinations of the various elements depicted in FIGS. 1-9.

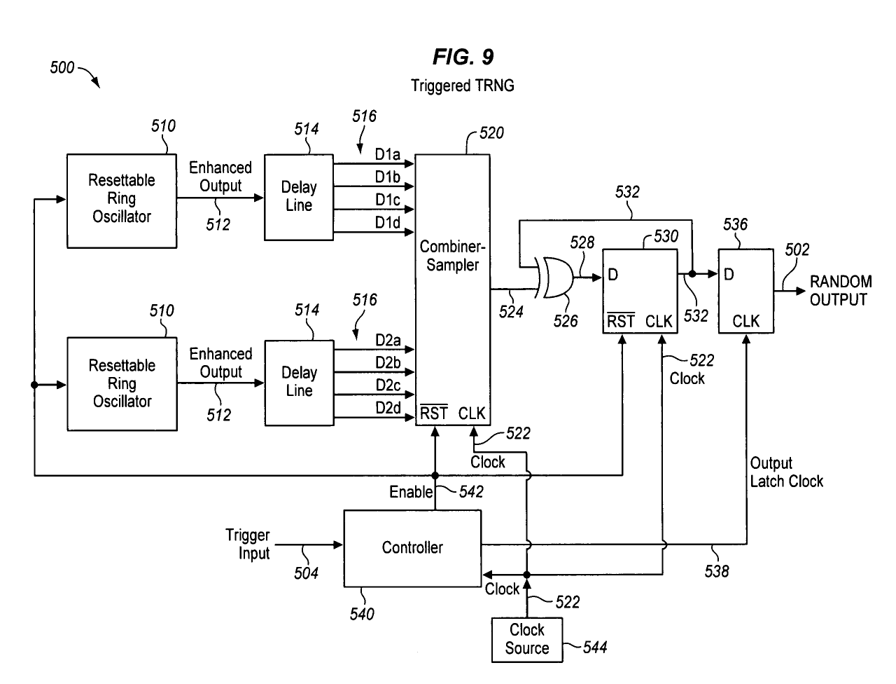

FIG. 9 contains a block diagram of a triggerable TRNG 500. TRNG 500 produces a random output bit 502 in response to an input trigger signal 504. A trigger signal 504 may be randomly timed or periodic. The randomness of random output 502 is not dependent on the timing of a trigger signal 504. Triggerable TRNG 500 comprises two or more resettable ring oscillators 510 of a type similar to ring oscillator 200 described with reference to FIG. 5. Each of ring oscillators 510 includes two or more taps that are combined into an enhanced output 512 in a manner described above with reference to FIGS. 1 and 2. Each of enhanced outputs 512 is connected to the input of a delay line 514 to produce a plurality of delayed outputs 516 in a manner as described above with reference to FIG. 3. The delayed outputs 516 are connected to a combiner-sampler 520 (e.g., such as combiner-sampler 160 described above with reference to FIG. 4). Combiner-sampler 520 is clocked by a clock signal 522 to produce a random output 524, which output 524 is further connected to a two-input XOR gate 526. XOR gate 526 drives the data input 528 of a continuous XOR latch 530 and the output 532 of latch 530 if fed back to the other input of XOR gate 526. Output 532 of continuous XOR latch 530 is finally connected to an output latch 536 that stores final random output 502 in response to an output latch clock 538 from a controller circuit 540. Controller circuit 540 accepts trigger inputs 504 and produces control signals 538, 542 for resettable ring oscillators 510, combiner-sampler 520, continuous XOR latch 530, and output latch clock 538 for latching the random output 502.

Controller 540 responds to a trigger input 504 and clock signal 522 from clock source 544 by first ensuring that ring oscillators 510, combiner-sampler 520 and each of latches 530, 536 are in a reset state. Then, controller 540 enables ring oscillators 510 by setting an enable signal 542 to a high state. Controller 540 also allows combiner-sampler 520 and latch 530 (which are reset while the enable signal is in a low state) to begin sampling and latching, respectively, in response to clock signal 522. Controller 540 counts a set number of clocks, each of which produces a single sample in combiner-sampler 520, and then sends a single output latch clock pulse 538 to latch the final continuously XOR-ed bit into random output latch 536. Then, controller 540 again sets enable signal 542 to a low state, resetting ring oscillators 510, the latches in combiner-sampler 520 and continuous XOR latch 530. Controller 540 and the rest of triggerable TRNG 500 are then ready to accept another trigger signal 504 and generate another random output 502.

Triggerable TRNG 500 produces random numbers that are inherently independent because TRNG 500 is in a reset state between each generation cycle. The reset state removes any trace or “memory” of previously generated numbers, so there is no autocorrelation in a sequence of random outputs from the generator. In addition, during the generation of a single output, the probability of any bit being a 1 or a 0 is made very close to the ideal 50%. This results from a combination of: the enhanced jitter in the enhanced outputs of each ring oscillator; the multiple samplings and combinations from the delayed outputs; and the continuous XOR-ing of a number of combiner-sampler outputs to produce a final output bit 502. Continuous XOR latch 530 functions to produce the accumulated XOR-ed result of all the bits previously clocked into the latch since it was last reset.

A preferred embodiment of a triggerable TRNG 500 contains two resettable rings, one with 12 gates and three equally-spaced taps, and one with 9 gates and three equally-spaced taps. The enhanced outputs are sent through two delay lines, each with 8 delayed output taps. The first four delayed outputs from each delay line are sent to a first combiner-sampler of the type described with reference to FIG. 4, and the second set of delayed outputs, D1e-D1h and D2e-D2h, is sent to a second combiner-sampler. The outputs from both combiner-samplers are further combined in a two-input XOR gate. The output of the XOR gate is connected to a continuous XOR function latch and finally to a random bit output latch, as described with reference to FIG. 9. In an exemplary preferred embodiment, the clock signal is a 200 MHz clock signal supplied by a 20 MHz oscillator multiplied by a phase-locked loop (PLL) frequency multiplier. The controller sets the number of clocks to 97 clocks for sampling, to two clocks for resetting, and to one clock for latching out the output bit (a total of 100 clocks). This results in a generation time of 0.5 microseconds for each output.

The bias and autocorrelation (of at least the first 32 orders) of a sequence of bits generated in a preferred embodiment of a triggerable TRNG are each smaller than ±0.00001 (10 ppm). In a more preferred embodiment of a triggerable TRNG, the bias and autocorrelation (of at least the first 32 orders) of a sequence of generated bits are each smaller than ±0.000001 (1 ppm).

An exemplary triggerable TRNG is embedded in a Cyclone III field-programmable gate array (FPGA) commercially available from Altera Corporation. The TRNG occupies only 112 logic elements (LE's), including 18 LE's for a controller, and consumes only about 14 milliwatts (mW) of power at a generation rate of 2 megabits per second (Mbps). Although a triggerable TRNG was described herein to include two combiner-samplers similar to combiner-sampler 160 depicted in FIG. 4, one skilled in the art will recognize that a single combiner-sampler that contains all the required components of two combiner-samplers is functionally equivalent to the two combiner-samplers.

Advantages of triggerable TRNG include: small number of gates used in the chip; low power consumption; high speed; low cost; good statistical properties; easy transport to other programmable and custom integrated circuits; and the unique property of producing a true random number in response to a trigger input. This property of producing a true random number in response to a trigger input makes the triggerable TRNG output similar to the results of a quantum measurement, but with better statistical properties and ease of manufacture. In some embodiments, multiple TRNGs are operated in parallel to produce word sizes as large as desired, such as 16, 32 or 64 bits wide. In some embodiments, words are used with a weighted summation, similar to finite impulse response (FIR) digital filtering, to produce Gaussian (normally-distributed) random numbers. Optionally, the Gaussian (normally-distributed) random numbers are sent as further output through a digital-to-analog converter (DAC) to produce a random white noise analog signal for testing or other purposes.

Embodiments in accordance with the invention are useful as components of mental influence detectors with applications in various areas of anomalous cognition and machine-enhanced anomalous cognition. Some specific areas of utilization include communications, enhanced decision making, medical diagnosis and treatment options, enhanced computing machines, lie detection, enabling the handicapped, locating lost or hidden objects, and increasing correct prediction probabilities for everything from games of “chance” to market moves.

The particular systems, devices and methods described herein are intended to illustrate the functionality and versatility of the invention, but should not be construed to be limited to those particular embodiments. It is evident that those skilled in the art may now make numerous uses and modifications of the specific embodiments described, without departing from the inventive concepts. It is also evident that the steps recited may, in some instances, be performed in a different order; or equivalent structures and processes may be substituted for the structures and processes described. Since certain changes may be made in the above systems and methods without departing from the scope of the invention, it is intended that all subject matter contained in the above description or shown in the accompanying drawings be interpreted as illustrative and not in a limiting sense. Consequently, the invention is to be construed as embracing each and every novel feature and novel combination of features present in or inherently possessed by the systems, devices and methods described in the claims below and by their equivalents.

What is claimed is:

1. A true random number generator in an integrated circuit, comprising:
a plurality of independent ring oscillators, each of said ring oscillators having a plurality of gates, a plurality of sampling taps and an Exclusive-Or (XOR) function, wherein each of said sampling taps is operable to tap an output signal from one of said gates, and said XOR function is operable to receive a plurality of outputs signals from said gates to produce enhanced output;
a plurality of delay lines, each of said delay lines comprising a plurality of gates and a plurality of sampling taps, wherein each of said delay lines is operable to receive enhanced output from one of said ring oscillators, each of said sampling taps is operable to tap an output signal from one of said gates, and each of said delay lines is operable to generate a plurality of progressively delayed output signals.
a combiner-sampler, said combiner sampler having a plurality of primary XOR gates, a plurality of secondary XOR gates, and a plurality of data latches, each data latch being operable to latch data from an XOR gate, wherein each of said primary XOR gates is operable to combine pairs of said delayed output signals from different delay lines to produce a primary output signal, and said secondary XOR gates are operable together to combine signals latched from a plurality of said primary output signals to produce a random binary output; and
a source of a clock signal to clock said data latches in said combiner-sampler.

2. A true random number generator as in claim 1 wherein:
said integrated circuit comprises a programmable logic circuit.

3. A true random number generator as in claim 1 wherein:
said plurality of ring oscillators being operable to accept inputs for resetting.

4. A method for generating a sequence of true random numbers in an integrated circuit comprising:
providing a clock signal;
providing at least two output signals from each of at least two independent ring oscillators;
combining said at least two output signals into an enhanced oscillator output for each of the said ring oscillators;
producing at least two delayed output signals in a signal delay circuit from each of the said enhanced oscillator outputs;
using said clock signal and said delayed output signals to produce a multiplicity of sampled signals; and
combining said sampled signals in an output combiner circuit to produce a sequence of random numbers.

5. A method for generating a sequence of true random numbers as in claim 4 wherein:
said steps of combining said at least two output signals and said step of combining said sampled signals are performed by an XOR function.

6. A resettable true random number generator in an integrated circuit, comprising:
a resettable ring oscillator having a plurality of gates, an enable input connected to at least one of said gates, said enable input being operable to reset said ring oscillator;
a pulse generator, said pulse generator being operable to produce a precisely controlled, short pulse triggered by an input signal;
a counter for counting cycles from said ring oscillator; and
a source of an initiator signal, said ring oscillator operating asynchronously from any other clock signal.

7. A triggerable true random number generator in an integrated circuit comprising:
at least one resettable ring oscillator, said at least one resettable ring oscillator having a plurality of gates, a plurality of sampling taps and an XOR function, wherein each of said sampling taps is operable to tap an output signal from one of said gates, and said XOR function is operable to receive a plurality of output signals from said gates to produce enhanced output;
at least one delay line comprising a plurality of gates and a plurality of sampling taps, wherein said at said least one delay line is operable to receive said enhanced output from said at least one resettable ring oscillator, each of said sampling taps is operable to tap an output signal from one of said gates, and said at least one delay line is operable to generate a plurality of progressively delayed output signals;
a resettable combiner-sampler having a plurality of data latches and a plurality of secondary XOR gates, wherein each of said data latches is operable to latch one of said progressively delayed output signals to produce a latched primary output signal, and said secondary XOR gates are operable together to combine said latched primary output signals into a combiner-sampler output;
a controller for accepting a trigger input for initiating a random number generation, wherein said controller is operable to provide an enable output for enabling said at least one resettable ring oscillator and resetting said data latches in said resettable combiner-sampler, and is further operable to provide a latch clock for latching said combiner-sampler output in an output latch to produce a random output; and
a source of a clock signal for clocking said controller, said data latches in said resettable combiner-sampler and said output latch.

8. A triggerable true random number generator in an integrated circuit as in claim 7, further comprising:
a continuous XOR latch operable to accept said resettable combiner-sampler output to produce a continuous XOR output;
wherein said output latch is operable to accept said continuous XOR output to produce said random output.

9. A triggerable true random number generator in an integrated circuit as in claim 7, comprising:
two resettable ring oscillators and two delay lines; and
a resettable combiner-sampler having a plurality of primary XOR gates, a plurality of secondary XOR gates, and a plurality of data latches, wherein each data latch is operable to latch data from an XOR gate, each of said primary XOR gates is operable to combine pairs of said delayed output signals from different delay lines to produce a latched primary output signal, and said secondary XOR gates are operable together to combine said latched primary output signals into a combiner-sampler output.

10. A triggerable true random number generator in an integrated circuit as in claim 9, further comprising:
a continuous XOR latch operable to accept said resettable combiner-sampler output to produce a continuous XOR output;
wherein said output latch is operable to accept said continuous XOR output to produce said random output.

11. A triggerable true random number generator in an integrated circuit as in claim 10 wherein;
the fractional bias and the first 32 orders of autocorrelation measured in an output sequence produced by said triggerable true random number generator are less than 10 ppm with 95% statistical confidence.

12. A triggerable true random number generator in an integrated circuit as in claim 10 wherein;
the fractional bias and the first 32 orders of autocorrelation measured in an output sequence produced by said triggerable true random number generator are less than 1 ppm with 95% statistical confidence.
